(19) United States
(12) Patent Application Publication
(10) Pub. No.: US 2026/0179954 A1
(43) Pub. Date: Jun. 25, 2026

(54) BINDER COMPRISING COPOLYMER, NEGATIVE ELECTRODE FOR SECONDARY BATTERY COMPRISING BINDER, AND SECONDARY BATTERY COMPRISING NEGATIVE ELECTRODE

(71) Applicant: HANSOL CHEMICAL CO., LTD, Seoul (KR)

(72) Inventors: Ji-Hye PARK, Wanju-gun (KR); Min-Ki CHO, Wanju-gun (KR); So-Hyun PARK, Wanju-gun (KR); Chan-Su PARK, Wanju-gun (KR); Hyeon-Ji GWON, Wanju-gun (KR); Gyun-Tae KIM, Wanju-gun (KR); Chang-Beom KIM, Wanju-gun (KR); Se-Man KWON, Wanju-gun (KR)

(21) Appl. No.: 19/127,539

(22) PCT Filed: Nov. 8, 2023
(86) PCT No.: PCT/KR2023/017814

§ 371 Date: May 6, 2025

(30) Foreign Application Priority Data
Nov. 8, 2022 (KR) 10-2022-0147993

(51) Int. Cl. H01M 4/62; C08F 220/56; C09D 5/24; C09D 133/26; H01M 4/02; H01M 10/052

(52) U.S. Cl. CPC H01M 4/622; C08F 220/56; C09D 5/24; C09D 133/26; H01M 10/052; C08F 2800/20; H01M 2004/027

(57) ABSTRACT

The present invention relates to a copolymer, and a copolymer composition, negative electrode slurry, negative electrode, and secondary battery comprising same, the copolymer comprising an acrylic acid-based monomer unit, an acrylamide-based monomer unit, and a monomer unit including a sulfonic acid group.

### TECHNICAL FIELD

The present disclosure relates to a copolymer that can be used as a binder, a copolymer composition containing the same, a slurry, an electrode, and a secondary battery.

### BACKGROUND ART

Lithium secondary batteries have a high energy density. Thus, lithium secondary batteries are widely used in the electrical, electronic, communication, and computer industries. Lithium secondary batteries have seen an expansion of their application areas from small-sized lithium secondary batteries for portable electronic devices to high-capacity secondary batteries for hybrid vehicles and electric vehicles.

With the expansion of their application areas, lithium secondary batteries are required to have higher capacity and longer lifespan characteristics. An example of a method for increasing the capacity of lithium secondary batteries is using an active material containing silicon atoms for the negative electrode.

When an active material containing silicon atoms, which experiences a large amount of lithium intercalation/deintercalation, is applied, improvement in battery capacity can be expected, compared to conventional carbon-based active materials. However, the silicon-containing active material undergoes a significant volume change due to the lithium intercalation/deintercalation, which causes a negative electrode active material layer to expand and contract considerably during charging and discharging.

As a result, the electrical conductivity between the negative electrode active materials decreases, or the conductive path between the active material and the current collector becomes blocked, leading to a deterioration in the cycle characteristics of the secondary battery.

Additionally, during the preparation of a negative electrode slurry using silicon as the negative electrode active material, the application of a highly basic binder may result in the generation of bubbles and gases within the slurry.

The generation of these bubbles and gases occurs because silicon is oxidized upon contact with water, generating hydrogen (H₂). In particular, the generation of hydrogen can be promoted by bases. Meanwhile, generated bubbles and gases can greatly reduce the dispersibility of a slurry and, at the same time, cause coating defects in an electrode process.

Therefore, there is a demand for a binder that solves these problems and makes it possible to secure secondary batteries with excellent characteristics.

### RELATED ART DOCUMENT

### Patent Document

(Patent Document 1) Korean Patent Application Publication No. 10-2013-0117901

### DISCLOSURE

### Technical Problem

Accordingly, an objective of the present disclosure is to provide a copolymer and a copolymer composition. The copolymer suppresses the generation of bubbles and gases during the preparation of a slurry (e.g., a negative electrode slurry using a silicon negative electrode active material), thereby improving the dispersibility of the slurry. As a result, the copolymer exhibits excellent electrical conductivity and superior stability and coating properties.

In addition, another objective of the present disclosure is to provide a slurry composition with an excellent ability to suppress electrode swelling using the copolymer and copolymer composition.

In addition, a further objective of the present disclosure is to provide an electrode (particularly a negative electrode) with excellent performance to which the slurry composition is applied, and to provide a secondary battery including the electrode, exhibiting excellent initial efficiency characteristics, resistance characteristics, and life characteristics (capacity retention rate).

However, the problems that the present disclosure seeks to solve are not limited to the problems mentioned above, and other problems not mentioned will be clearly understood by those skilled in the art from the description below.

### Technical Solution

One aspect of the present disclosure provides a copolymer, containing
an acrylic acid-based monomer unit, an acrylamide-based monomer unit, and a monomer unit containing a sulfonic acid group.

Another aspect of the present disclosure provides a copolymer composition, containing
the copolymer; and
an ionic compound.

A further aspect of the present disclosure provides a negative electrode slurry, containing
the copolymer; and
a negative active material.

A yet further aspect of the present disclosure provides a negative electrode, including
a current collector; and
a negative active material layer containing the copolymer formed on the current collector.

A still yet further aspect of the present disclosure provides
a secondary battery, including
the negative electrode.

### Advantageous Effects

The copolymer and copolymer composition of the present disclosure can suppress the generation of bubbles and gases during the preparation of a slurry, thereby improving the dispersibility of the slurry. The copolymer and copolymer composition of the present disclosure also enhances the ability to suppress electrode swelling, thereby contributing to the improved initial efficiency characteristics, resistance characteristics, and life characteristics (capacity retention rate) of a lithium secondary battery.

### DESCRIPTION OF DRAWINGS

FIG. 1 shows a photograph of the gas generated after a slurry using polyvinyl alcohol as a binder in Comparative Example 1 of the present disclosure was left for 72 hours; and

FIG. 2 shows a photograph taken when observing phase separation, which occurred after a slurry of Comparative Example 3 of the present disclosure was left for 5 days.

### BEST MODE

Hereinafter, the operation and effects of the present disclosure will be described in more detail through specific embodiments of the present disclosure. However, these embodiments are merely presented as examples of the present disclosure, and the scope of rights of the present disclosure is not determined by the embodiments.

Prior to this, terms and words used in this specification and claims should not be construed as limited to their ordinary or dictionary meanings. Based on the principle that the inventors can appropriately define the concept of the term to explain his or her invention in the best way, the terms and words are required to be interpreted as meaning and concept consistent with the technical idea of the present disclosure.

Therefore, the configuration of the embodiments described in this specification is only one of the most preferred embodiments of the present disclosure and does not represent the entire technical idea of the present disclosure. It should be understood that at the time of filing this application, there may be various equivalents and modifications that can replace the embodiments.

In this specification, singular expressions include plural expressions, unless the context clearly indicates otherwise. In this specification, terms such as “include”, “comprise”, or “have” are intended to indicate the presence of implemented features, numbers, steps, components, or combinations thereof. The terms should be understood as not precluding the presence or addition of one or more other features, numbers, steps, components, or combinations thereof.

In this specification, “a to b” and “a to b” that indicate numerical ranges, “to” and “˜” are defined as ≥ a and ≤ b.

The copolymer according to one aspect of the present disclosure may contain an acrylic acid-based monomer unit, an acrylamide-based monomer unit, and a monomer unit containing a sulfonic acid group.

The copolymer has strong rigidity. Due to that, the copolymer may suppress the volume expansion of silicon when applied to a negative electrode slurry in which silicon is used as a negative electrode active material.

In other words, through the acrylic acid-based monomer unit, the copolymer contains many carboxyl groups, enabling effective reaction with silicon. In addition, the copolymer has rigidity. This enables the copolymer to effectively suppress the expansion of silicon.

Meanwhile, through the acrylamide-based monomer unit, the copolymer may maintain the heat resistance of an electrode and interact with the surface of silicon particles, which serve as the negative electrode active material.

In addition, the monomer unit containing a sulfonic acid group may increase the electrical conductivity of the copolymer, enabling enhancement of the electrical characteristics of a secondary battery when the copolymer is applied to the secondary battery.

In particular, the acrylic acid-based monomer and the monomer unit containing a sulfonic acid group may lower the pH of a slurry by releasing acid (H⁺) in water. Through this, the generation of gases and hydrogen, which is promoted under alkaline conditions, may be suppressed in the slurry.

In one embodiment, the copolymer may contain 20% to 40% by weight of the acrylic acid-based monomer unit, 50% to 70% by weight of the acrylamide-based monomer unit, and 1% to 20% by weight of the monomer unit containing a sulfonic acid group, based on 100% by weight of the copolymer.

When the acrylic acid-based monomer unit is contained in an amount exceeding the range, dispersibility may decrease, which may lead to reduced electrode coating properties.

In addition, when the acrylamide-based monomer unit is contained in an amount below the range, the glass transition temperature of the copolymer may be lowered, which may lead to reduced heat resistance when the copolymer is applied to an electrode.

Meanwhile, when the monomer unit containing a sulfonic acid group is contained in an amount exceeding the range, the glass transition temperature of the copolymer may be increased, which may lead to reduced flexibility of an electrode.

In another embodiment, the acrylic acid-based monomer unit may be formed by polymerizing one or more types selected from the group consisting of an acrylic acid, a methacrylic acid, an ethyl acrylic acid, a propyl acrylic acid, and an itaconic acid.

In addition, the acrylamide-based monomer may be formed by polymerizing one or more types selected from the group consisting of acrylamide and methacrylamide.

Meanwhile, the monomer unit containing a sulfonic acid group may be formed by polymerizing one or more types selected from the group consisting of a 2-acrylamido-2-methyl propane sulfonic acid, a vinyl sulfonic acid, and a 4-styrene sulfonic acid.

In a further embodiment, the copolymer may contain a repeated monomer unit represented by Formula 1 below.

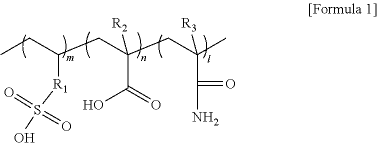

In Formula 1 above,

R₁ is —CH₂⁻, —C₆H₄⁻, or —CONHC(CH₃)₂CH₂⁻. R₂ is hydrogen, a linear or branched hydrocarbon having 1 to 4 carbon atoms, or —CH₂COOH. R₃ is hydrogen or a linear or branched hydrocarbon having 1 to 4 carbon atoms. m, n, and 1 satisfy the equation of m+n+1=1.

m, n, and 1 in Formula 1 correspond to the weight percentage of each monomer unit. The sum of the weight percentage of each monomer unit is 1.

For example, R₂ to R₃ in Formula 1 may each independently include one or more selected from the group consisting of hydrogen, methyl, ethyl, propyl, and isopropyl.

In a yet further embodiment, the copolymer may be a random or block copolymer.

In a still yet further embodiment, the weight average molecular weight of the copolymer may be in a range of 100,000 to 1,000,000.

A copolymer composition according to another aspect of the present disclosure may contain the copolymer and an ionic compound.

The ionic compound is used with the copolymer, increasing the electrical conductivity of the copolymer composition. In addition, the stability of an electrode slurry, to which the copolymer composition is applied, may be improved.

Through this, the initial efficiency and capacity retention rate of a secondary battery, including an electrode, to which the copolymer composition is applied, are improved, and the electrical resistance of the secondary battery is reduced, thereby enhancing the performance of the secondary battery.

In a still yet further embodiment, the ionic compound may include Na₂SO₄, MgCl₂, KCl, NaCl, NH₄Cl, Na₂CO₃, ethylenediaminetetraacetic acid (EDTA), or a combination thereof.

In a still yet further embodiment, the copolymer composition may have a pH of 4 to 7, and the copolymer composition may have an electrical conductivity of 2 S/m to 4 S/m.

In other words, the copolymer composition of the present disclosure has a significantly low pH range compared to polyvinyl alcohol, which is used as a typical electrode binder. When the copolymer composition is used for an electrode slurry, the copolymer composition may suppress the generation of gases and H₂, which is promoted under alkaline conditions as described above, in an electrode slurry.

A copolymer composition according to a further aspect of the present disclosure may contain the copolymer and a negative active material.

In other words, the copolymer may be used as a binder for a negative electrode, and in particular, the binder may be an aqueous binder.

The negative electrode active material may be a compound containing one or more types selected from the group consisting of carbon-based materials, silicon, alkali metals, alkaline earth metals, Group 13 elements, Group 14 elements, transition metals, and rare earth elements. The negative electrode active material may preferably be silicon or a compound containing silicon.

The carbon-based material may be, for example, artificial graphite, natural graphite, hard carbon, and soft carbon, but is not limited thereto. The type of the negative electrode active material containing silicon is not particularly limited as long as it is silicon or a compound containing silicon. The negative electrode active material may preferably be one or more types selected from the group consisting of Si, SiOₓ (0<x<2), Si—Y alloys (where Y is an alkali metal, alkaline earth metal, Group 13 element, Group 14 element, transition metal, rare earth element, or a combination thereof, but not Si.), and Si—C composite.

In addition, when using a mixture of a negative electrode active material containing silicon and another negative electrode active material, the negative electrode active material containing silicon may account for 8% or more by weight, based on the total weight of the negative electrode active material.

The other negative electrode active material may account for 50% to 99% by weight, preferably 60% to 80% by weight, based on the total weight of the negative electrode active material layer.

When the negative electrode active material accounts for less than 50% by weight, the energy density may decrease, making it impossible to manufacture a battery with high energy density. When the negative electrode active material accounts for more than 99% by weight, the content of the conductive material and binder may decrease, reducing electrical conductivity and also reducing adhesion strength between the electrode active material layer and the current collector.

Meanwhile, the copolymer of the present disclosure may account for 18 to 35% by weight, based on the total weight of the negative electrode slurry. When the copolymer accounts for less than 1% by weight, the physical properties of a negative electrode may deteriorate, which may cause the negative electrode active material and conductive material to fall off. When the copolymer accounts for more than 35% by weight, the ratio of the negative electrode active material and a conductive material may be relatively reduced, which may cause reduced battery capacity and reduced electrical conductivity of the negative electrode.

In addition, the negative electrode slurry may further contain a polymer in addition to the copolymer composition of the present disclosure. The polymer may specifically, for example, include any one selected from the group consisting of polyvinylidene fluoride (PVDF), polyvinyl alcohol (PVA), polyacrylic acid (PAA) polyacrylic acid metal salt (Metal-PAA), polymethacrylic acid (PMA), polymethyl methacrylate (PMMA), polyacrylamide (PAM), polymethacrylamide, polyacrylonitrile (PAN), polymethacrylonitrile, polyimide (PI), chitosan, starch, polyvinylpyrrolidone, tetrafluoroethylene, polyethylene, polypropylene, ethylene-propylene-diene polymer (EPDM), sulfonated-EPDM, styrene-butadiene rubber (SBR), fluorine rubber, hydroxypropylcellulose, regenerated cellulose, and various copolymers thereof but is not limited thereto.

A negative electrode according to a yet further aspect of the present disclosure may include a current collector and a negative electrode active material layer containing the copolymer of the present disclosure formed on the current collector.

The negative electrode active material layer may further include a conductive material. The conductive material is used to further improve the conductivity of the negative electrode active material. This conductive material is not particularly limited as long as it is conductive without causing chemical changes in the battery. For example, the conductive material may include any one selected from the group consisting of graphites such as natural graphite and artificial graphite; carbon black, such as carbon black, acetylene black, Ketjen black, channel black, furnace black, lamp black, and summer black; conductive fibers such as carbon fiber and metal fiber; metal powders such as carbon fluoride, aluminum, and nickel powder; conductive whiskers such as zinc oxide and potassium titanate; conductive metal oxides such as titanium oxide; and polyphenylene derivatives.

The conductive material may account for 0.5% to 30% by weight, preferably 60% to 80% by weight, preferably 15% to 25% by weight, based on the total weight of the negative electrode active material layer. When the conductive material accounts for less than 0.5% by weight, the electrical conductivity of a negative electrode is lowered. When the conductive material accounts for more than 30% by weight, the ratio of the silicon-based negative electrode active material and the binder is relatively reduced, reducing battery capacity. Since increasing the binder content is required to maintain the negative electrode active material layer, the content of the negative electrode active material decreases, making it impossible to manufacture a battery with high energy density.

In the negative electrode of the present disclosure, a negative electrode active material layer contains the copolymer of the present disclosure. Accordingly, the volume expansion of the negative electrode active material, which occurs during charging and discharging of the secondary battery, may be suppressed, while improving initial efficiency and capacity retention rate per cycle and lowering electrical resistance.

The negative electrode may be manufactured by a method including (a) preparing a composition for forming a negative electrode active material layer containing a negative electrode active material and the copolymer composition of the present disclosure and (b) applying the composition for forming the negative electrode active material layer onto a negative electrode current collector and then drying it.

The composition for forming the negative electrode active material layer is prepared in the form of a negative electrode slurry. It is most preferable that the solvent for preparing the composition in the slurry state is to be easy to dry and to be capable of dissolving a binder of the copolymer composition of the present disclosure well, while maintaining a negative electrode active material in a dispersed state without dissolving it.

The solvent according to the present disclosure may be water or an organic solvent. The organic solvent applicable may be an organic solvent containing one or more selected from the group consisting of methylpyrrolidone, dimethylformamide, isopropyl alcohol, acetonitrile, methanol, ethanol, and tetrahydrofuran.

The composition for forming a negative electrode active material layer may be mixed in a conventional manner using a conventional mixer, such as a rate mixer, high-speed shear mixer, or homomixer.

The step (b) is a step of manufacturing a negative electrode for a lithium secondary battery by applying the composition for forming a negative electrode active material layer prepared in the step (a) onto a negative electrode current collector and drying it.

The negative electrode current collector may be specifically selected from the group consisting of copper, stainless steel, titanium, silver, palladium, nickel, alloys thereof, and combinations thereof. The stainless steel may be surface-treated with carbon, nickel, titanium, or silver. Aluminum-cadmium alloys may be used as the alloys. In addition, calcined carbon, non-conductive polymer surface-treated with a conductive material, or conductive polymer may be used.

The composition for forming the negative electrode active material layer prepared in the step (a) is applied onto a negative electrode current collector. The composition may be applied for coating onto a current collector at an appropriate thickness, depending on the thickness to be formed. The thickness may be appropriately selected, preferably within the range of 10 to 300 μm.

At this time, the method of applying the composition for forming a slurry-type negative electrode active material layer is not limited. For example, methods such as doctor blade coating, dip coating, gravure coating, slit die coating, spin coating, comma coating, bar coating, reverse roll coating, screen coating, cap may be performed for the coating preparation of the negative electrode active material layer.

After application and drying, a negative electrode for a secondary battery (particularly a lithium secondary battery), which has a negative electrode active material layer finally formed, may be manufactured.

A battery according to a still yet further aspect of the present disclosure may include a current collector and a negative electrode with a negative electrode active material layer formed on the current collector.

The battery may be a secondary battery (particularly, a lithium secondary battery) including a positive electrode, a negative electrode, a separator interposed between the positive electrode and the negative electrode, and an electrolyte solution.

The initial efficiency of the secondary battery may be 80% or more, and the electrical resistance may be 0.02Ω or less.

In addition, when charging and discharging of the secondary battery is repeated for 100 cycles, the capacity retention rate may be 90% or more.

The composition of the positive electrode, separator, and electrolyte solution of the lithium secondary battery is not particularly limited in the present disclosure and follows what is known in the field.

The positive electrode includes a positive electrode active material provided on the positive electrode current collector.

The positive electrode current collector is not particularly limited as long as it has high conductivity without causing chemical changes in the battery. For example, the positive electrode current collector may include any one selected from the group consisting of stainless steel, aluminum, nickel, titanium, calcined carbon, or aluminum or stainless steel that has been surface-treated with carbon, nickel, titanium, or silver. At this time, the positive electrode current collector is designed to increase adhesion strength with the positive electrode active material. For this, various forms such as films, sheets, foils, nets, porous materials, foams, and non-woven materials with fine irregularities on the surface may be used.

Any positive electrode active material available in the technical field may be used as the positive electrode active material constituting a positive electrode active material layer. Specific examples of the positive electrode active material may include lithium metals; lithium cobalt-based oxides such as LiCoO₂; lithium manganese-based oxides such as Li₁₊ₓMn₂₋ₓO₄ (where x is 0 to 0.33), LiMnO₃, LiMn₂O₃, and LiMnO₂; lithium copper oxides such as LizCuO₂; vanadium oxides such as LiV₃O₈, LiFe₃O₄, V₂O₅, Cu₂V₂O₇; lithium nickel-based oxides expressed as LiNi₁₋ₓMₓO₂ (where, M=Co, Mn, Al, Cu, Fe, Mg, B, or Ga, and x=0.01 to 0.3); lithium manganese composite oxides expressed as LiMn₂₋ₓMₓO₂ (where, M=Co, Ni, Fe, Cr, Zn, or Ta, and x=0.01 to 0.1) or Li₂Mn₃MO₈ (where M=Fe, Co, Ni, Cu, or Zn); lithium-nickel-manganese-cobalt-based oxides expressed as Li(NiₐCo_{b}Mn_{c}) O₂ (where, 0<a<1, 0<b<1, 0<c<1, a+b+c=1); sulfur or disulfide compounds; phosphates such as LiFePO₄, LiMnPO₄, LiCoPO₄, and LiNiPO₄; and Fe₂ (MoO₄)₃ but the positive electrode active material is not limited thereto.

At this time, the positive electrode active material layer may further contain binders, conductive materials, fillers, and other additives in addition to the positive electrode active material. The conductive material is the same as that described above of a negative electrode for a lithium secondary battery.

In addition, the binder may include any one selected from the group consisting of polyvinylidene fluoride (PVDF), polyvinyl alcohol (PVA), polyacrylic acid (PAA), polymethacrylic acid (PMA), polymethyl methacrylate (PMMA), polyacrylamide (PAM), polymethacrylamide, polyacrylonitrile (PAN), polymethacrylonitrile, polyimide (PI), chitosan, starch, regenerated cellulose, hydroxypropylcellulose, polyvinylpyrrolidone, tetrafluoroethylene, polyethylene, polypropylene, ethylene-propylene-diene polymer (EPDM), sulfonated-EPDM, styrene-butadiene rubber (SBR) fluorine rubber, and various copolymers thereof but is not limited thereto.

The separator may be made of a porous substrate. The porous substrate may be any porous substrate commonly used in electrochemical devices. The porous substrate may include, for example, a polyolefin-based porous membrane or non-woven fabric but is not particularly limited thereto.

The separator may be a porous substrate made of any one selected from the group consisting of or a mixture of two or more of polyethylene, polypropylene, polybutylene, polypentene, polyethylene terephthalate, polybutylene terephthalate, polyester, polyacetal, polyamide, polycarbonate, polyimide, polyetheretherketone, polyethersulfone, polyphenylene oxide, polyphenylene sulfide, and polyethylene naphthalate.

The electrolyte solution of the lithium secondary battery is a non-aqueous electrolyte solution containing lithium salt and is made of lithium salt and a solvent. The solvent used is any one selected from the group consisting of a non-aqueous organic solvent, an organic solid electrolyte, and an inorganic solid electrolyte.

The lithium salt is a material easily soluble in the non-aqueous electrolyte solution. The lithium salt may include, for example, any one selected from the group consisting of LiCl, LiBr, LiI, LiClO₄, LiBF₄, LiB₁₀Cl₁₀, LiPF₆, LiAsF₆, LiSbF₆, LiAlCl₄, LiSCN, LiC₄BO₈, LiCF₃CO₂, LiCH₃SO₃, LiCF₃SO₃, LiN(SO₂CF₃)₂, LiN(SO₂F)₂, LIN (SO₂C₂F₅)₂, LiC₄FgSO₃, LiC(CF₃SO₂)₃, (CF₃SO₂)· 2NLi, lithium chloroborane, lithium of lower aliphatic carboxylic acids, and lithium 4-phenyl borate imide.

The non-aqueous organic solvent may include, for example, any non-polar organic solvent selected from the group consisting of N-methyl-2-pyrrolidone, propylene carbonate, ethylene carbonate, butylene carbonate, dimethyl carbonate, diethyl carbonate, ethylmethyl carbonate, gamma-butyrolactone, 1,2-dimethoxy ethane, 1,2-diethoxy ethane, tetrahydroxy franc (franc), 2-methyl tetrahydrofuran, dimethyl sulfoxide, 1,3-dioxolane, 4-methyl-1,3-dioxene, diethyl formamide, ether, dimethylformamide, dioxolane, acetonitrile, nitromethane, methyl formate, methyl acetate, phosphoric acid triester, trimethoxy methane, dioxolane derivative, sulfolane, methylsulfolane, 1,3-dimethyl-2-imidazolidinone, propylene carbonate derivatives, tetrahydrofuran derivatives, ether, methyl propionate, and ethyl propionate.

The organic solid electrolyte may include, for example, any one selected from the group consisting of polyethylene derivatives, polyethylene oxide derivatives, polypropylene oxide derivatives, phosphate ester polymer, poly agitation alcohol, polyvinylidene lysine, polyester sulfide, polyvinyl fluoride, and polymers containing secondary dissociation groups.

The inorganic solid electrolyte may include, for example, any one selected from the group consisting of nitrides of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, halides, and sulfates.

In addition, the non-aqueous electrolyte solution may further contain other additives for the purpose of improving charge/discharge characteristics and flame retardancy. The additives may include any one selected from the group consisting of pyridine, triethyl phosphite, triethanolamine, cyclic ethers, diamine, ethylene n-glyme, hexaphosphate triamide, nitrobenzene derivatives, sulfur, quinone imine dye, N-substituted oxazolidinone, N, N-substituted imidazolidine, ethylene glycol dialkyl ether, ammonium salt, pyrrole, 2-methoxyethanol, aluminum trichloride, fluoroethylene carbonate (FEC), propene sultone (PRS), and vinylene carbonate (VC).

The lithium secondary battery according to the present disclosure may be subjected to a lamination stack and folding process of a separator and electrode in addition to a general winding process. In addition, the battery case may be cylindrical, prismatic, pouch-shaped, or coin-shaped.

### Mode for Disclosure

Hereinafter, the present disclosure will be described in more detail using examples, but the present disclosure is not limited thereto.

### Example 1

1120 g of distilled water was added to a reactor and stirred while purging with nitrogen. As monomers, 12 g of 2-acrylamido-2-methyl propane sulfonic acid (AMPS), 60 g of acrylic acid (AA), and 120 g of acrylamide (AM) were each added at a constant rate along with 0.5 g of an initiator.

After maintaining the temperature for 4 hours, 0.5 to 5 g of Na₂SO₄ was added, the mixture was stirred for 1 hour, and the reaction was terminated. As a result, a poly(2-acrylamido-2-methyl propane sulfonic acid)-polyacrylic acid-polyacrylamide (PAMPS-PAA-PAM) copolymer composition was obtained.

A negative electrode slurry of 10 g of a 9% by weight aqueous copolymer composition synthesized in a slurry preparation vessel, 5.8 g of Si, 23.1 g of graphite, and 1.2 g of a conductive material was prepared.

Distilled water was further added to adjust a solid content of the slurry to 55% to 58% by weight.

As the conductive material, single-walled carbon nanotubes, double-walled carbon nanotubes, multi-walled carbon nanotubes, Super P, or a combination thereof were used.

### Example 2

1120 g of distilled water was added to a reactor and stirred while purging with nitrogen. As monomers, 26 g of 2-acrylamido-2-methyl propane sulfonic acid (AMPS), 53 g of acrylic acid (AA), and 106 g of acrylamide (AM) were each added at a constant rate along with 0.5 g of an initiator.

After maintaining the temperature for 4 hours, Na₂SO₄ was added, the mixture was stirred for 1 hour, and the reaction was terminated. As a result, a poly(2-acrylamido-2-methyl propane sulfonic acid)-polyacrylic acid-polyacrylamide (PAMPS-PAA-PAM) copolymer composition was obtained.

A negative electrode slurry of 10 g of a 9% by weight aqueous copolymer composition synthesized in a slurry preparation vessel, 5.8 g of Si, 23.1 g of graphite, and 1.2 g of a conductive material was prepared.

Distilled water was further added to adjust a solid content of the slurry to 55% to 58% by weight.

### Comparative Example 1

A negative electrode slurry of 18 g of a 5% by weight polymer aqueous solution of polyvinyl alcohol (weight average molecular weight: 476,000), 5.8 g of Si, 23.1 g of graphite, and 1.2 g of a conductive material was prepared in a slurry preparation vessel.

Distilled water was further added to adjust a solid content of the slurry to 55% to 58% by weight.

### Comparative Example 2

A negative electrode slurry of 7.5 g of a 12% by weight polymer aqueous solution of polyacrylic acid (viscosity average molecular weight: 450,000), 5.8 g of Si, 23.1 g of graphite, and 1.2 g of a conductive material was prepared in a slurry preparation vessel.

Distilled water was further added to adjust a solid content of the slurry to 55% to 58% by weight.

### Comparative Example 3

1120 g of distilled water was added to a reactor and stirred while purging with nitrogen. As monomers, 12 g of 2-acrylamido-2-methyl propane sulfonic acid (AMPS), 60 g of acrylic acid (AA), and 120 g of acrylamide (AM) were each added at a constant rate along with 0.5 g of an initiator.

After maintaining the temperature for 4 hours, the mixture was stirred for 1 hour, and the reaction was terminated. As a result, a poly(2-acrylamido-2-methyl propane sulfonic acid)-polyacrylic acid-polyacrylamide (PAMPS-PAA-PAM) copolymer composition was obtained.

A negative electrode slurry of 10 g of a 9% by weight aqueous copolymer composition synthesized in a slurry preparation vessel, 5.8 g of Si, 23.1 g of graphite, and 1.2 g of a conductive material was prepared.

Distilled water was s further added to adjust a solid content of the slurry to 55% to 58% by weight.

### [Preparation Example] Preparation of Lithium Secondary Battery

The slurries prepared in Examples 1 and 2 and Comparative Examples 1 to 3 were uniformly applied onto copper current collectors as the negative electrode slurry. Then, after drying at 110° C., the resulting electrode composites were roll-pressed and then heat-treated in a vacuum oven at 110° C. for 4 hours or more to prepare negative electrodes.

Next, a non-aqueous electrolyte solution containing lithium salt was used as an electrolyte, and a polyolefin separator was interposed between the positive electrode and the negative electrode in each case. Afterward, lithium secondary batteries were manufactured regardless of whether they were pouch-type or coin cell-type.

The non-aqueous electrolyte was prepared by adding 5% by weight of FEC and 1% by weight of LiP₂FP into a solvent of ethylene carbonate, ethyl methyl carbonate, and diethyl carbonate mixed in a volume ratio of 2:1:7, and dissolving LiPF₆ electrolyte in the mixture at a concentration of 1.5 M.

### [Evaluation Example 1] Evaluation of Polymer pH and Polymer Electrical Conductivity

pH and electrical conductivity of the copolymers and polymers prepared and used in Examples 1 and 2 and Comparative Examples 1 to 3 were measured at 25° C. with a PH meter (Mettler Toledo, S220) and an electrical conductivity meter (TOADKK, EC METER CM-25R), respectively.

### [Evaluation Example 2] Gas Generation and Stability of Slurry

The slurries prepared in Examples 1 and 2 and Comparative Examples 1 to 3 were placed in a transparent glass vessel and left for 72 hours to visually observe gas generation. In other words, gas generation could be confirmed through bubbles created on the wall of the glass vessel.

In addition, the slurries prepared in Examples 1 and 2 and Comparative Examples 1 to 3 were placed in a transparent glass vessel, respectively, and left for 5 days, and phase separation in each case was observed with the naked eye.

### [Evaluation Example 3] Adhesion Strength Evaluation

To measure the adhesion strength of the slurries prepared in Examples 1 and 2 and Comparative Examples 1 to 3, the copper current collectors of the negative electrodes prepared in the secondary battery manufacturing process of the Preparation Example and the negative electrode slurry layers formed on the copper current collectors were used for 180° peeling using UTM to measure adhesion strength.

### [Evaluation Example 4] Battery Performance Measurement

### (1) DC-IR Measurement

After the initial formation of lithium secondary batteries manufactured according to the Preparation Example using the slurries prepared by Examples 1 and 2 and Comparative Examples 1 to 3 as the negative electrode slurry, DC-IR measurements were made under the condition of charging in CC/CV mode at a 0.3 C rate to a voltage corresponding to 50% of SOC and then discharging at 2.75 V at a 2 C rate for 10 seconds. At this time, the temperature of the chamber in each case was 25° C.

### (2) Capacity Retention Rate

The lithium secondary batteries prepared, using the slurries prepared as the negative electrode slurry in Examples 1 and 2 and Comparative Examples 1 to 3, as described in Preparation Example were charged and discharged three times under the conditions of temperature of 25° C., charge/discharge current density of 0.1 C, charge end voltage of 4.2 V, and discharge end voltage of 2.7 V.

Then, the secondary batteries were charged and discharged 100 times at a charge/discharge current density of 1 C, a charge end voltage of 4.2 V, and a discharge end voltage of 2.7 V, and the capacity retention rates thereof were measured.

All discharges were performed constant under current/constant voltage conditions, and the termination current during the constant voltage discharge was set to 0.005 C.

At this time, the initial efficiency was calculated according to Equation 1 below, and the capacity retention rates were calculated according to Equation 2 below.

$$Initial efficiency [ \% ] = ( Discharge capacity in 1 st cycle / Charge capacity in 1 st cycle ) \times 100 \qquad [ Equation 1 ]$$

$$Capacity retention rate ( \% ) = ( Discharge capacity after 100 cycles / Discharge capacity after 3 cycles ) \times 100 \qquad [ Equation 2 ]$$

The pH and electrical conductivity of the polymer, and the gas generation and stability of the slurry measured in Evaluation Examples 1 and 2 are shown in Table 1 below.

TABLE 1

| | | | | | Slurry |
|---|---|---|---|---|---|
| | | | | | stability |
| | Electrical | | Binder | Gas | (After leaving |
| | conductivity | | pH | generation | for 5 days) |
| Example 1 | 3.55 | S/m | 4.8 | X | Good |
| Example 2 | 3.55 | S/m | 4.1 | X | Good |
| Comparative | 1.64 | S/m | 10 | ◯ | Good |
| Example 1 | | | | | |
| Comparative | 190 | mS/m | 2.4 | X | Poor |
| Example 2 | | | | | |
| Comparative | 1.5 | S/m | 4.8 | X | Poor |

Example 3

(In Table 1 above, the “O” for gas generation corresponds to the case where gas generation was confirmed in the slurry left for 72 hours. The “X” corresponds to cases where gas generation was not confirmed. In addition, the “Good” slurry stability corresponds to the cases where phase separation did not occur after leaving for 5 days. The “Poor” corresponds to the cases where phase separation occurred after being left for 5 days.)

As shown in Table 1 above, the electrical conductivity of the copolymers containing Na₂SO₄ used in Examples 1 and 2 was higher than that of polyvinyl alcohol and polyacrylic acid, which were common binder polymers used in Comparative Examples 1 and 2.

In addition, the copolymer used in Comparative Example 3, which was the same as the copolymer of Example 1 except that it did not contain Na₂SO₄, exhibited low electrical conductivity compared to the copolymer of Example 1.

On the other hand, the pH of polyvinyl alcohol and polyacrylic acid in Comparative Examples 1 and 2 was 10 and 2.4, respectively, which was higher or lower than the pH of the copolymers containing Na₂SO₄ in Examples 1 and 2.

Additionally, when comparing the copolymer of Example 1 and the copolymer of Comparative Example 3, it was confirmed that the inclusion of Na₂SO₄ did not affect the pH of the copolymers.

On the other hand, the slurries of Examples 1 and 2 and Comparative Examples 2 and 3 did not generate gas after being left for 72 hours.

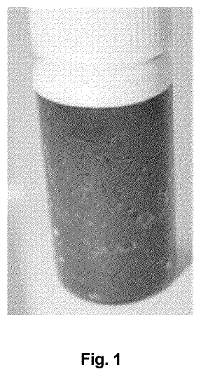

In contrast, in the slurry in Comparative Example 1 in which polyvinyl alcohol was used as a binder, gas generation was confirmed after being left for 72 hours, as shown in FIG. 1.

In addition, the slurries of Examples 1 and 2 and Comparative Example 1 showed good slurry stability because phase separation did not occur even after being left for 5 days.

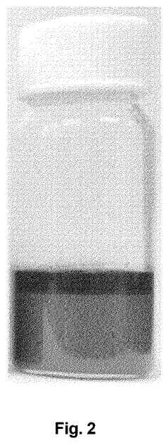

In contrast, the slurry of Comparative Example 2 used as a binder for polyacrylic acid and the slurry of Comparative Example 3 using the same copolymer as the copolymer of Example 1, except that it did not contain Na₂SO₄, underwent phase separation after being left for 5 days, as shown in FIG. 2.

The adhesion strength, slurry gas generation, and battery performance measured in Evaluation Examples 3 and 4 are shown in Table 2 below.

TABLE 2

| | | | | Capacity |
|---|---|---|---|---|
| | Adhesion | Initial | | retention rate |
| | strength | efficiency | Resistance | @100 cycle |
| | (gf/mm) | (%) | (Ω) | (%) |
| Example 1 | 8 | 80.21 | 0.0147 | 91.17 |
| Example 2 | 8.6 | 81.9 | 0.0149 | 92.69 |
| Comparative | 10 | 69.5 | 0.0267 | 71.99 |
| Example 1 | | | | |
| Comparative | 5 | 65.2 | 0.0287 | 70.50 |
| Example 2 | | | | |
| Comparative | 8.1 | 74.62 | 0.0231 | 84.75 |
| Example 3 | | | | |

As shown in Table 2, the adhesion strength of the slurry using polyacrylic acid as a binder in Comparative Example 2 was low compared to that of the slurries in Examples 1 and 2.

On the other hand, compared to the batteries using the negative electrodes, to which the negative electrode slurries of Examples 1 and 2 were applied, the lithium secondary batteries using the negative electrode, to which the negative electrode slurries of Comparative Examples 1 to 3 were applied, exhibited low initial efficiency and high battery resistance.

In addition, compared to the batteries using the negative electrode, to which the negative electrode slurries of Examples 1 and 2 were applied, the capacity retention rate of the lithium secondary batteries using the negative electrode, to which the negative electrode slurries of Comparative Examples 1 and 2 were applied, was reduced.

The battery using the negative electrode applied with the negative electrode slurry of Comparative Example 3, which used the same copolymer as that of Example 1 except that it did not contain Na₂SO₄, exhibited a decrease in capacity retention rate compared to the battery using the negative electrode, to which the negative electrode slurry of Example 1 was applied.

Consequently, the copolymer composition containing the copolymer and ionic compound of the present disclosure had excellent electrical conductivity and an appropriate pH. As a result, it was confirmed that gas generation during slurry preparation was suppressed, and the stability of the slurry was improved.

In addition, it was confirmed that the copolymer composition containing the copolymer and ionic compound of the present disclosure improved excellent initial efficiency, resistance, and capacity retention rate when applied to secondary batteries.

The scope of the present disclosure is indicated by the claims described later rather than the detailed description above. The meaning and scope of the patent claims, and all changes or modified forms derived from the equivalent concept thereof, should be construed as being included in the scope of the present disclosure.

### INDUSTRIAL APPLICABILITY

The copolymer and copolymer composition of the present disclosure can suppress the generation of bubbles and gases during the preparation of a slurry, thereby improving the dispersibility of the slurry. The copolymer and copolymer composition of the present disclosure also enhances the ability to suppress electrode swelling, thereby contributing to the improved initial efficiency characteristics, resistance characteristics, and life characteristics (capacity retention rate) of a lithium secondary battery.

1. A copolymer, comprising:
an acrylic acid-based monomer unit,
an acrylamide-based monomer unit, and
a monomer unit containing a sulfonic acid group.

2. The copolymer of claim 1, wherein the copolymer comprises 20% to 40% by weight of the acrylic acid-based monomer unit, 50% to 70% by weight of the acrylamide-based monomer unit, and 1% to 20% by weight of the monomer unit comprising a sulfonic acid group, based on 100% by weight of the copolymer.

3. The copolymer of claim 1, wherein the acrylic acid-based monomer unit is formed by polymerizing one or more types selected from the group consisting of an acrylic acid, a methacrylic acid, an ethyl acrylic acid, a propyl acrylic acid, and an itaconic acid, and
the acrylamide-based monomer is formed by polymerizing one or more types selected from the group consisting of acrylamide and methacrylamide.

4. The copolymer of claim 1, wherein the monomer unit comprising a sulfonic acid group is formed by polymerizing one or more types selected from the group consisting of a 2-acrylamido-2-methyl propane sulfonic acid, a vinyl sulfonic acid, and a 4-styrene sulfonic acid.

5. The copolymer of claim 1, wherein the copolymer comprises a repeated monomer unit represented by Formula 1 below, 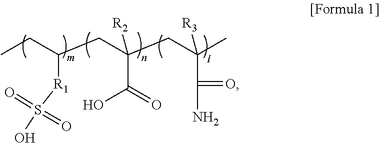
wherein, in Formula 1 above,
R₁ is —CH₂, —C₆H₄, or —CONHC(CH₃)₂CH₂,
R₂ is hydrogen, a linear or branched hydrocarbon having 1 to 4 carbon atoms, or —CH₂COOH,
R₃ is hydrogen or a linear or branched hydrocarbon having 1 to 4 carbon atoms, and
m, n, and 1 satisfy the equation of m+n+1=1.

6. The copolymer of claim 1, wherein the copolymer is a random or block copolymer.

7. The copolymer of claim 1, wherein the weight average molecular weight of the copolymer is in a range of 100,000 to 1,000,000.

8. A copolymer composition, comprising:
the copolymer of claim 1; and
an ionic compound.

9. The copolymer composition of claim 8, wherein the ionic compound comprises Na₂SO₄, MgCl₂, KCl, NaCl, NH₄Cl, Na₂CO₃, ethylenediaminetetraacetic acid (EDTA), or a combination thereof.

10. The copolymer composition of claim 8, wherein the copolymer composition has a pH of 4 to 7, and
the copolymer composition has an electrical conductivity of 2 S/m to 4 S/m.

11. A negative electrode slurry, comprising:
the copolymer of claim 1; and
a negative active material.

12. A negative electrode, comprising:
a current collector; and
a negative electrode active material layer, comprising the copolymer of claim 1, formed on the current collector.

13. A secondary battery, comprising:
the negative electrode of claim 12.
